(19) United States
(12) Patent Application Publication
(10) Pub. No.: US 2025/0037924 A1
(43) Pub. Date: Jan. 30, 2025

(54) INDUCTOR COMPONENT

(71) Applicant: Murata Manufacturing Co., Ltd., Kyoto-fu (JP)

(72) Inventors: Yugo TAKEOKA, Nagaokakyo-shi (JP); Kenichi TANI, Nagaokakyo-shi (JP); Yuuichirou YOSHIDA, Nagaokakyo-shi (JP)

(73) Assignee: Murata Manufacturing Co., Ltd., Kyoto-fu (JP)

(21) Appl. No.: 18/783,332

(22) Filed: Jul. 24, 2024

(30) Foreign Application Priority Data
Jul. 25, 2023 (JP) 2023-120868

(51) Int. Cl. H01F 27/28

(52) U.S. Cl. CPC H01F 27/2804; H01F 2027/2809

(57) ABSTRACT

An inductor component includes an element body, a coil in the element body and spirally wound along an axis, and first and second outer electrodes in the element body and electrically connected to the coil. The first and second outer electrodes are at least on the bottom surface of the element body. The axis is parallel to the bottom surface and intersects the first and second side surfaces of the element body. When viewed from an axial direction, the inner diameter of the coil includes a first inner diameter dimension in a length direction in which the first and second end surfaces of the element body face each other and a second inner diameter dimension in a height direction in which the top and bottom surfaces of the element body face each other.

### CROSS-REFERENCE TO RELATED APPLICATION

This application claims benefit of priority to Japanese Patent Application No. 2023-120868, filed Jul. 25, 2023, the entire content of which is incorporated herein by reference.

### BACKGROUND

### Technical Field

The present disclosure relates to an inductor component.

### Background Art

Conventional inductor components include the one described in Japanese Unexamined Patent Application Publication No. 2013-153009. Such an inductor component has an element body, a coil provided in the element body and spirally wound along an axis, and a first outer electrode and a second outer electrode provided in the element body and electrically connected to the coil. The shape of the inner peripheral surface of the coil is a horizontally long substantially rectangle extending along the outer surface of the element body and the vicinity of the first outer electrode and the second outer electrode, when viewed from the axial direction.

### SUMMARY

However, in a conventional inductor component such as the one described above, since the shape of the inner peripheral surface of the coil is a horizontally long rectangle, the line length of the coil becomes large. Thus, there is a concern that the resistance of the coil may become large and the ratio of the Q value to the L value may decrease.

Therefore, the present disclosure provides an inductor component capable of suppressing the decrease in the ratio of the Q value to the L value while securing the L value.

An inductor component according to an aspect of the present disclosure includes an element body; a coil provided in the element body and spirally wound along an axis; and a first outer electrode and a second outer electrode provided in the element body and electrically connected to the coil. The element body includes a first end surface and a second end surface facing each other, a first side surface and a second side surface facing each other, a bottom surface connected between the first end surface and the second end surface and between the first side surface and the second side surface, and a top surface facing the bottom surface. The first outer electrode and the second outer electrode are provided at least on the bottom surface, and the axis is parallel to the bottom surface and intersects the first side surface and the second side surface. Also, when viewed from an axial direction, the inner diameter of the coil includes a first inner diameter dimension in a length direction in which the first end surface and the second end surface face each other and a second inner diameter dimension in a height direction in which the top surface and the bottom surface face each other, and the inner diameter dimension of one of the first inner diameter dimension and the second inner diameter dimension is larger than the inner diameter dimension of the other. In addition, the ratio of the absolute value of the difference between the inner diameter dimension of the aforesaid one and the inner diameter dimension of the aforesaid other to the inner diameter dimension of the aforesaid other is 0.1% or more and 11% or less (i.e., from 0.1% to 11%).

Here, the inner diameter of the coil is the diameter of the inner side of the coil when viewed from the axial direction; and when the coil is wound around one or more turns in a plane perpendicular to the axis, the diameter of the innermost side of the coil when viewed from the axial direction is the inner diameter of the coil. When transparently viewed in the axial direction, when a part or all of the winding portion of the coil overlap, the inner diameter of the coil is the diameter of the innermost side of the overlapping part of the winding portion of the coil. The first inner diameter dimension is the dimension of the largest inner diameter in the inner diameters of the coil in the length direction when viewed from the axial direction. The second inner diameter dimension is the dimension of the largest inner diameter in the inner diameters of the coil in the height direction when viewed from the axial direction.

According to the above aspect, the ratio of the difference in inner diameter dimension, in other words, the difference in the ratio between the inner diameter dimensions is 0.1% or more, which enables the area of the inner side of the coil to be large compared to the case where the shape of the inner peripheral surface of the coil is a perfect circle, thus securing the L value. Since the ratio of the difference in inner diameter dimension is 11% or less, the line length of the coil can be shortened to reduce the resistance compared to the case where the shape of the inner peripheral surface of the coil is a horizontally long or vertically long ellipse or rectangle, and the ratio of the Q value to the L value, i.e., the value of Q value/L value, can be kept at 2.5 or higher. Therefore, by making the shape of the inner peripheral surface of the coil closer to a perfect circle or square, the value of Q value/L value can be kept at 2.5 or higher while securing the L value. By keeping the value of Q value/L value at 2.5 or higher, the Q value acquisition efficiency can be improved.

With the inductor component according to an aspect of the present disclosure, the decrease in the ratio of the Q value to the L value can be suppressed while securing the L value.

### BRIEF DESCRIPTION OF THE DRAWINGS

FIG. 1 is a perspective view of an inductor component according to a first embodiment;

FIG. 2 is a transparent front view of the inductor component when viewed from the side of a first side surface;

FIG. 3A is an exploded plan view of the inductor component;

FIG. 3B is an exploded plan view of the inductor component;

FIG. 4 is a transparent front view of the inductor component when viewed from the side of the first side surface;

FIG. 5 is a transparent front view of an inductor component according to a second embodiment when viewed from the side of a first side surface of the inductor component;

FIG. 6A is an exploded plan view of the inductor component;

FIG. 6B is an exploded plan view of the inductor component;

FIG. 7 is a transparent front view of an inductor component according to a third embodiment when viewed from the side of a first side surface of the inductor component;

FIG. 8A is an exploded plan view of the inductor component;

FIG. 8B is an exploded plan view of the inductor component;

FIG. 8C is an exploded plan view of the inductor component;

FIG. 9A is an example of a graph showing the relationship between the ratio between the inner diameter dimensions and the ratio of the Q value to the L value;

FIG. 9B is a graph showing the relationship between the ratio between the inner diameter dimensions and the L value; and

FIG. 9C is a graph showing the relationship between the ratio between the inner diameter dimensions and the Q value.

### DETAILED DESCRIPTION

An inductor component, which is an aspect of the present disclosure, will be described below with the embodiments shown in the drawings. Note that the drawings are partially schematic and do not necessarily reflect actual dimensions or proportions.

### First Embodiment

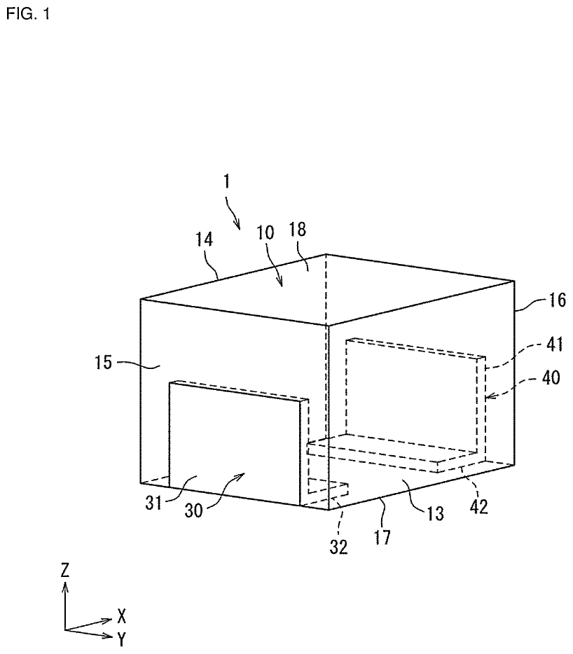

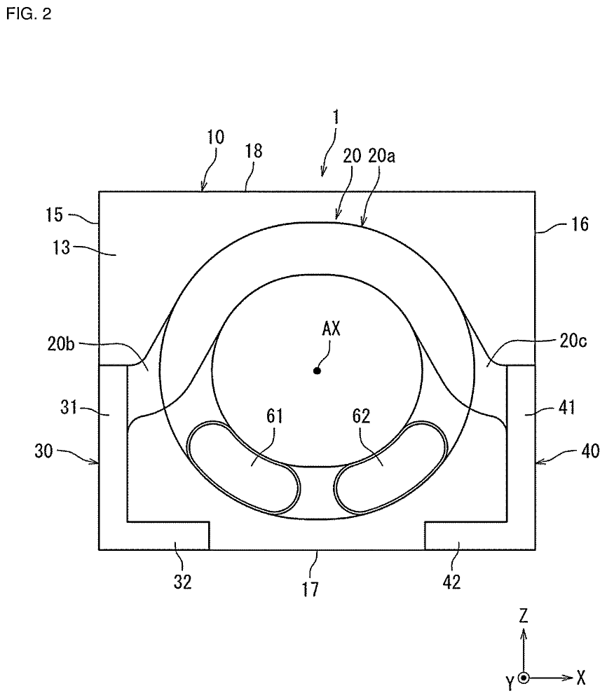

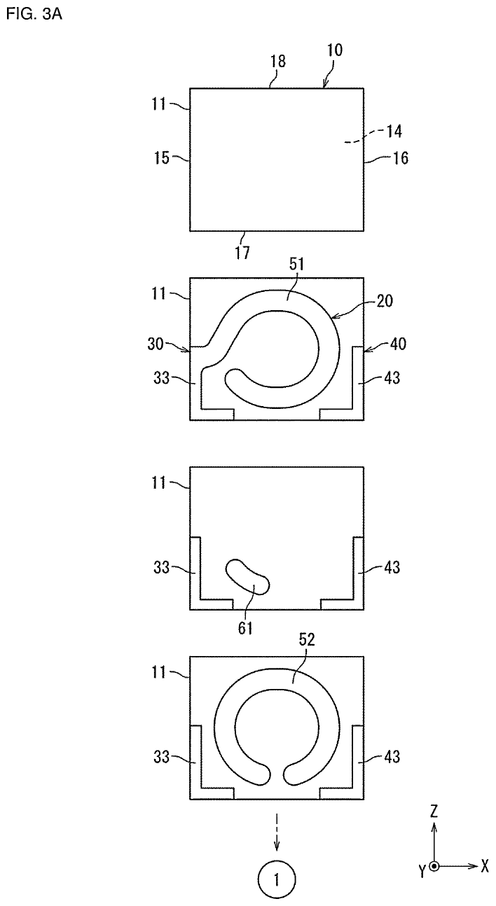

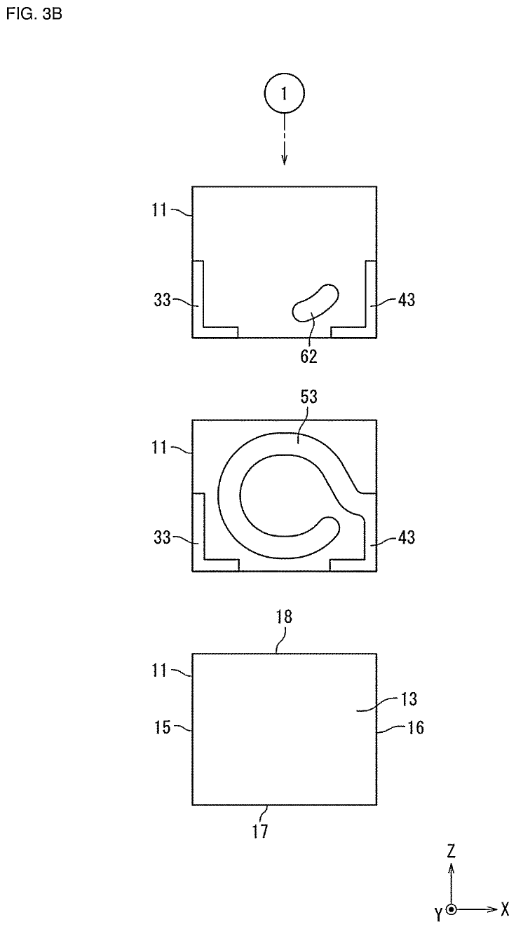

FIG. 1 is a perspective view of an inductor component according to a first embodiment. FIG. 2 is a transparent front view of the inductor component when viewed from the side of a first side surface. FIGS. 3A and 3B are exploded plan views of the inductor component. As shown in FIGS. 1, 2, 3A and 3B, an inductor component 1 has an element body 10, a coil 20 provided in the element body 10 and spirally wound along an axis AX, and a first outer electrode 30 and a second outer electrode 40 provided in the element body 10 and electrically connected to the coil 20. For convenience, the element body and coil are depicted transparently in FIG. 2 so that the structure can be easily understood, but the element body and coil may be translucent or opaque.

The inductor component 1 is electrically connected to the wiring of a circuit board (not shown) via the first and second outer electrodes 30 and 40. The inductor component 1 is used, for example, as a coil for impedance matching (matching coil) in a high-frequency circuit, and is used in electronic equipment such as a PC, a DVD player, a digital camera, a TV, a cellular phone, car electronics, and medical and industrial machines. However, the inductor component 1 are not limited to be used in the example described above, but can also be used in, for example, a tuning circuit, a filter circuit and a rectifier/smoothing circuit or the like.

The element body 10 is formed in a substantially parallelepiped shape. The surfaces of the element body 10 includes a first end surface 15 and a second end surface 16 facing each other, a first side surface 13 and a second side surface 14 facing each other, a bottom surface 17 connected between the first end surface 15 and the second end surface 16 and between the first side surface 13 and the second side surface 14, and a top surface 18 facing the bottom surface 17. When the inductor component 1 is mounted on a mounting substrate (not shown), the bottom surface 17 is the surface facing the mounting substrate.

As shown in the drawings, the X direction is a direction orthogonal to the first end surface 15 and the second end surface 16, and oriented from the first end surface 15 to the second end surface 16. The Y direction is a direction orthogonal to the first side surface 13 and the second side surface 14 and oriented from the second side surface 14 to the first side surface 13. The Z direction is a direction orthogonal to the bottom surface 17 and the top surface 18 and oriented from the bottom surface 17 to the top surface 18. The X direction, Y direction, and Z direction are orthogonal to each other and form a left-handed system when arranged in the order of X, Y, and Z.

The X direction is also referred to as the length direction of the element body 10, the Y direction is also referred to as the width direction of the element body 10, and the Z direction is also referred to as the height direction of the element body 10. The length direction is a direction in which the first end surface 15 and the second end surface 16 face each other, and is a direction parallel to a straight line connecting the first end surface 15 and the second end surface 16 at the shortest distance. The width direction is a direction in which the first side surface 13 and the second side surface 14 face each other, and is a direction parallel to a straight line connecting the first side surface 13 and the second side surface 14 at the shortest distance. The height direction is a direction in which the top surface 18 and bottom surface 17 face each other, and is a direction parallel to a straight line connecting the top surface 18 and the bottom surface 17 at the shortest distance.

The element body 10 is formed by stacking a plurality of insulating layers 11. The insulating layer 11 is made of, for example, a material containing borosilicate glass as the main component, a ferrite, a resin, or the like. The stacking direction of the insulating layer 11 is a direction (Y direction) parallel to the first and second end surfaces 15 and 16 and the bottom surface 17 of the element body 10. In other words, the insulating layer 11 is a layer spreading out in the XZ plane. The term “parallel” in the present application is not limited to strict parallelism, but also includes substantial parallelism, taking into account a realistic range of variation. Note that there is a possibility that the interface between the plurality of insulating layers 11 in the element body 10 is not clear due to sintering or the like. In FIGS. 3A and 3B, the direction from up to down is the stacking direction (Y direction).

The first outer electrode 30 and the second outer electrode 40 are made of a conductive material such as Ag, Cu, Au or an alloy containing these elements as main components. The first outer electrode 30 is provided continuously with the bottom surface 17 and the first end surface 15. The first outer electrode 30 is L-shaped. The first outer electrode 30 is embedded in the element body 10 so that it is exposed from the first end surface 15 and the bottom surface 17. The first outer electrode 30 has a first end surface portion 31 extending along the first end surface 15 and a first bottom surface portion 32 connected to the first end surface portion 31 and extending along the bottom surface 17.

The second outer electrode 40 is provided continuously with the bottom surface 17 and the second end surface 16. The second outer electrode 40 is L-shaped. The second outer electrode 40 is embedded in the element body 10 so that it is exposed from the second end surface 16 and the bottom surface 17. The second outer electrode 40 has a second end surface portion 41 extending along the second end surface 16 and a second bottom surface portion 42 connected to the second end surface portion 41 and extending along the bottom surface 17.

The first outer electrode 30 is formed by stacking a plurality of first outer electrode conductor layers 33 embedded in the element body 10 (the insulating layer 11). The second outer electrode 40 is formed by stacking a plurality of second outer electrode conductor layers 43 embedded in the element body 10 (the insulating layer 11). The first outer electrode conductor layer 33 extends along the first end surface 15 and the bottom surface 17, and the second outer electrode conductor layer 43 extends along the second end surface 16 and the bottom surface 17.

Thus, the first and second outer electrodes 30 and 40 can be embedded in the element body 10, so that miniaturization of the inductor component can be achieved compared to a configuration in which outer electrodes are externally attached to the element body 10. Further, since the coil 20 and the outer electrodes 30 and 40 can be formed in the same process thereby reducing positional variation between the coil 20 and the outer electrodes 30 and 40, variation in the electrical characteristics of the inductor component 1 can be reduced.

Note that the first outer electrode 30 may be composed of the first bottom surface portion 32 without the first end surface portion 31, and similarly, the second outer electrode 40 may be composed of the second bottom surface portion 42 without the second end surface portion 41. In other words, the first outer electrode 30 and the second outer electrode 40 may be provided at least on the bottom surface 17 of the element body 10.

The coil 20 is formed of, for example, the same conductive material as the first and second outer electrodes 30 and 40. The coil 20 is spirally wound along the stacking direction of the insulating layer 11. A first end of the coil 20 is connected to the first outer electrode 30 and a second end of the coil 20 is connected to the second outer electrode 40. In the present embodiment, the coil 20 and the first and second outer electrodes 30 and 40 are integrated and there is no clear boundary between them; however, the present disclosure is not limited thereto, and a boundary may exist if the coil and the outer electrodes are formed of different materials or by different methods.

The coil 20 is wound along the axis AX so that the axis AX is parallel to the bottom surface 17 and the axis AX intersects the first side surface 13 and the second side surface 14. The axis AX of the coil 20 coincides with the stacking direction (Y direction) of the insulating layer 11. The axis AX of the coil 20 means the central axis of the spiral shape of the coil 20.

The coil 20 has a winding portion 20a, a first extended portion 20b connected between a first end of the winding portion 20a and the first outer electrode 30, and a second extended portion 20c connected between a second end of the winding portion 20a and the second outer electrode 40. In the present embodiment, the winding portion 20a and the first and second extended portions 20b and 20c are integrated and there is no clear boundary between them; however, the present disclosure is not limited thereto, and a boundary may exist if the winding portion and the extended portions are formed of different materials or by different methods.

The winding portion 20a is spirally wound along the axis AX. In other words, the winding portion 20a refers to the portions of the coil 20 that are wound in a spiral shape overlapping each other when viewed in a direction parallel to the axis AX. The first and second extended portions 20b and 20c are the portions that are out of the overlapping portions.

When viewed from the direction of the axis AX of the coil 20, the shape of the coil 20 is bilaterally symmetrical with respect to a line passing through the axis AX of the coil 20 and parallel to the Z direction. Thus, the variation of the characteristics of the inductor component 1 can be suppressed. Specifically, the shape of the winding portion 20a of the coil 20 is a circular annulus when viewed from the axial AX direction. The shape of the inner peripheral surface of the coil 20 is circular, when viewed from the axial AX direction.

As shown in FIGS. 3A and 3B, the coil 20 has a plurality of coil wiring layers 51 to 53 stacked along the axis AX and a plurality of via wiring layers 61 and 62 each positioned between coil wiring layers adjacent to each other in the axial AX direction and connecting the coil wiring layers adjacent to each other in the axial AX direction. The plurality of coil wiring layers 51 to 53 are each provided in the insulating layer 11, and the plurality of via wiring layers 61 and 62 are each provided in the insulating layer 11. When viewed from the axial AX direction, the plurality of coil wiring layers 51 to 53 and the plurality of via wiring layers 61 and 62 extend along the spiral direction of the coil 20.

The plurality of coil wiring layers 51 to 53, each of which is wound along a plane and is electrically connected in series, constitute a spiral. The plurality of coil wiring layers 51 to 53 are formed by being wound on the main surface (XZ plane) of the insulating layer 11 orthogonal to the axial AX direction (Y direction). The number of turns of each of the coil wiring layers 51 to 53 is less than one turn, but may be one or more turns. The plurality of coil wiring layers 51 to 53 each have a circular arc shape when viewed from the axial AX direction.

The plurality of via wiring layers 61 and 62 pass through the insulating layer 11 in the thickness direction (Y direction). The plurality of via wiring layers 61 and 62 each have a circular arc shape when viewed from the axial AX direction. The length of each of the via wiring layers 61 and 62 in the extension direction is shorter than the length of each of the coil wiring layers 51 to 53 in the extension direction. The coil wiring layers adjacent to each other in the stacking direction are electrically connected in series via the via wiring layer. Thus, the plurality of coil wiring layers 51 to 53 constitute a spiral while being electrically connected in series with each other.

Each of the via wiring layers 61 and 62 extends along the spiral direction of the coil 20. Thus, the contact area between the via wiring layer and the coil wiring layer can be secured, thereby improving connection reliability. Further, since the via wiring layer extends along the spiral direction of the coil, the pad portion at the end portion of the coil wiring can be eliminated, thus preventing the reduction in the Q value caused by providing the pad portion.

Specifically, the first coil wiring layer 51, the second coil wiring layer 52, and the third coil wiring layer 53 are stacked in sequence along the Y direction. The end portion of the first coil wiring layer 51 is connected to the first outer electrode conductor layer 33 of the first outer electrode 30. The end portion of the third coil wiring layer 53 is connected to the second outer electrode conductor layer 43 of the second outer electrode 40.

The first via wiring layer 61 is positioned between the first coil wiring layer 51 and the second coil wiring layer 52 and connects the end portion of the first coil wiring layer 51 and the end portion of the second coil wiring layer 52. The second via wiring layer 62 is positioned between the second coil wiring layer 52 and the third coil wiring layer 53 and connects the end portion of the second coil wiring layer 52 and the end portion of the third coil wiring layer 53.

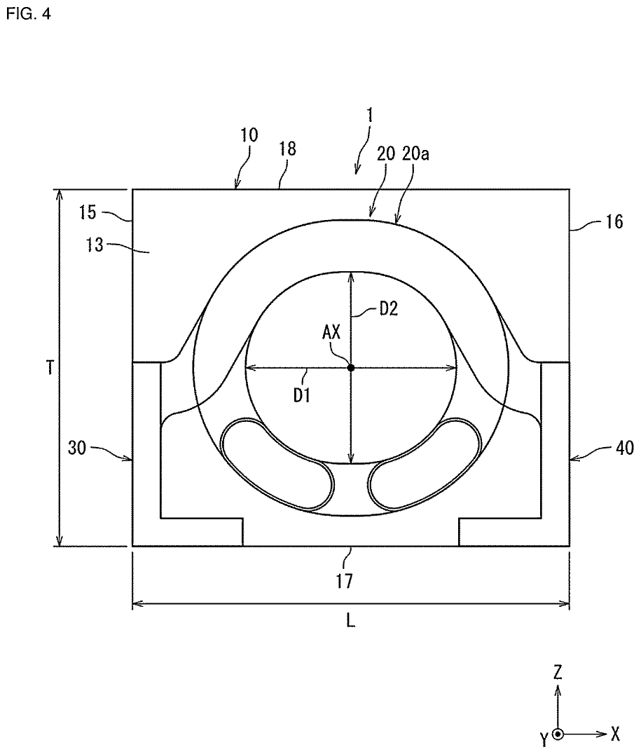

FIG. 4 is a transparent front view of the inductor component when viewed from the side of the first side surface. As shown in FIG. 4, when viewed from the axial AX direction, the inner diameter of the coil 20 includes a first inner diameter dimension D1 in the length direction (X direction) of the element body 10 and a second inner diameter dimension D2 in the height direction (Z direction) of the element body 10. The inner diameter dimension of one of the first inner diameter dimension D1 and the second inner diameter dimension D2 is larger than the inner diameter dimension of the other, and the ratio of the absolute value of the difference between the inner diameter dimension of the aforesaid one and the inner diameter dimension of the aforesaid other to the inner diameter dimension of the aforesaid other is 0.1% or more and 11% or less (i.e., from 0.1% to 11%). The ratio of the absolute value of the difference between the inner diameter dimension of the aforesaid one and the inner diameter dimension of the aforesaid other to the inner diameter dimension of the aforesaid other is also referred to as the difference between the ratio between the inner diameter dimensions and 100%.

The inner diameter of the coil 20 is the diameter of the inner side of the coil 20 when viewed from the axial AX direction. When the coil 20 is wound around one or more turns in a plane perpendicular to the axis AX, the diameter of the innermost side of the coil 20 when viewed from the axial AX direction is referred to as the inner diameter of the coil 20. When transparently viewed in the axial AX direction, when a part or all of the winding portion 20a of the coil overlap, the inner diameter of the coil 20 is the diameter of the innermost side of the overlapping portion of the winding portion 20a of the coil. The first inner diameter dimension D1 is the dimension of the largest inner diameter in the inner diameters of the coil 20 in the length direction when viewed from the axial AX direction. The second inner diameter dimension D2 is the dimension of the largest inner diameter in the inner diameters of the coil 20 in the height direction when viewed from the axial AX direction. The first inner diameter dimension D1 and the second inner diameter dimension D2 are measured, for example, by grinding the inductor component 1 along the XZ plane to expose the coil 20 and measuring the first inner diameter dimension D1 and the second inner diameter dimension D2.

Specifically, the first inner diameter dimension D1 is larger than the inner diameter dimension of the second inner diameter dimension D2, and the ratio of the absolute value of the difference between the first inner diameter dimension D1 and the second inner diameter dimension D2 to the second inner diameter dimension D2 (hereinafter simply referred to as “ratio of the difference in inner diameter dimension”) is 0.1% or more and 11% or less (i.e., from 0.1% to 11%). The ratio of the difference in inner diameter dimension is preferably 1% or more and 8% or less (i.e., from 1% to 8%), and more preferably 4% or more and 5% or less (i.e., from 4% to 5%). The difference between the first inner diameter dimension D1 and the second inner diameter dimension D2 is 0.15 μm or more and 1.5 μm or less (i.e., from 0.15 μm to 1.5 μm). When viewed from the axial AX direction, a first line segment corresponding to the first inner diameter dimension D1 and a second line segment corresponding to the second inner diameter dimension D2 intersect the axis AX, but it is also possible that at least one of the first line segment and the second line segment does not intersect the axis AX.

As shown in FIG. 4, when viewed from the axial AX direction, the dimension of the element body 10 in the length direction (hereinafter referred to as length dimension L) is larger than the dimension of the element body 10 in the height direction (hereinafter referred to as height dimension T). The length dimension L is the largest dimension of the element body 10 in the length direction when viewed from the axial AX direction. The height dimension T is the largest dimension of the element body 10 in the height direction when viewed from the axial AX direction.

Preferably, the length dimension L of the element body 10 is 0.20 mm or more and 0.30 mm or less (i.e., from 0.20 mm to 0.30 mm). The height dimension T of the element body 10 is 0.15 mm or more and 0.25 mm or less (i.e., from 0.15 mm to 0.25 mm). More preferably, the length dimension L of the element body 10 is 0.25 mm and the height dimension T of the element body 10 is 0.20 mm.

With the above configuration, since the ratio of the difference in inner diameter dimension is 0.1% or more, the area of the inner side of the coil 20 can be increased compared to the case where the shape of the inner peripheral surface of the coil is a perfect circle, thereby significantly improving the L value. Further, since the ratio of the difference in inner diameter dimension is 11% or less, the line length of the coil 20 can be shortened to reduce the resistance compared to the case where the shape of the inner peripheral surface of the coil is a horizontally long ellipse or rectangle, and the ratio of the Q value to the L value, i.e., the value of Q value/L value, can be kept at 2.5 or higher. Therefore, by keeping the shape of the inner peripheral surface of the coil 20 close to a perfect circle, the value of Q value/L value can be kept at 2.5 or higher while securing the L value. By keeping the value of Q value/L value at 2.5 or higher, the Q value acquisition efficiency can be improved.

Further, since the first inner diameter dimension D1 is larger than the second inner diameter dimension D2, when the length dimension L of the element body 10 is larger than the height dimension T of the element body 10, the shape of the inner peripheral surface of the coil 20 can be caused to correspond to the shape of the outer surface of the element body 10 when viewed from the axial AX direction. Thus, it is possible to effectively use the space inside the element body 10 with respect to the coil 20, increase the area of the inner side the coil 20, and improve the L value acquisition efficiency.

Further, since the first inner diameter dimension D1 is larger than the second inner diameter dimension D2, when the inductor component 1 is mounted on a mounting substrate so that the bottom surface 17 of the element body 10 faces the mounting substrate side, the coil 20 can be separated from the mounting substrate, thus reducing stray capacitance with the mounting substrate.

Further, since the length dimension L of the element body 10 is 0.20 mm or more and 0.30 mm or less (i.e., from 0.20 mm to 0.30 mm) and the height dimension T of the element body 10 is 0.15 mm or more and 0.25 mm or less (i.e., from 0.15 mm to 0.25 mm), the shape of the outer surface of the element body 10, when viewed from the axial AX direction, is suitable for the shape of the inner peripheral surface of the coil 20 in which the ratio of the difference in inner diameter dimension is 0.1% or more and 11% or less (i.e., from 0.1% to 11%), so that the space inside the element body 10 can be used effectively with respect to the coil 20.

Next, the manufacturing method of the inductor component 1 will be described.

As shown in FIGS. 3A and 3B, the inductor component 1 is manufactured by alternately stacking the first to third coil wiring layers 51 to 53 and the first and second via wiring layers 61 and 62 together with the insulating layer 11 from up to down in the drawings. The coil wiring layers 51 to 53 are provided in the insulating layer 11 by screen printing, for example. The via wiring layers 61 and 62 are provided by forming a cavity in the insulating layer 11 by photolithography or laser processing, for example, and forming the via wiring layer in the cavity by screen printing, for example.

### Second Embodiment

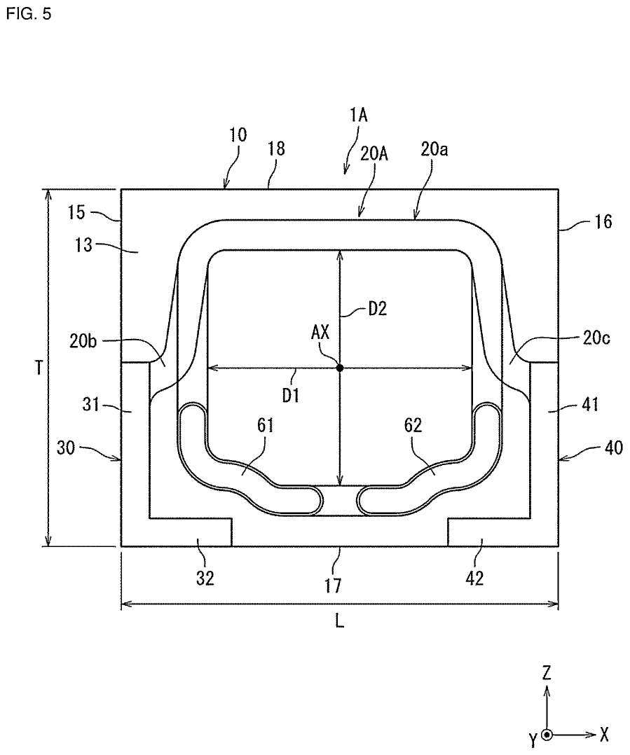

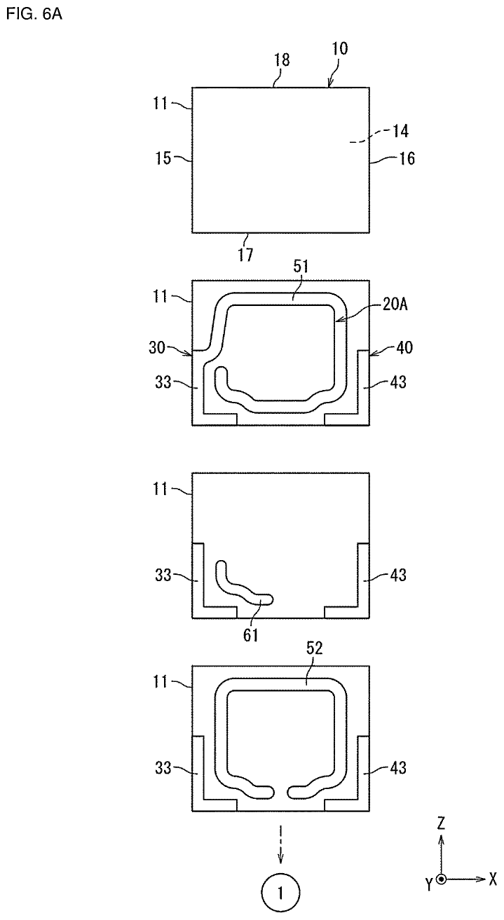

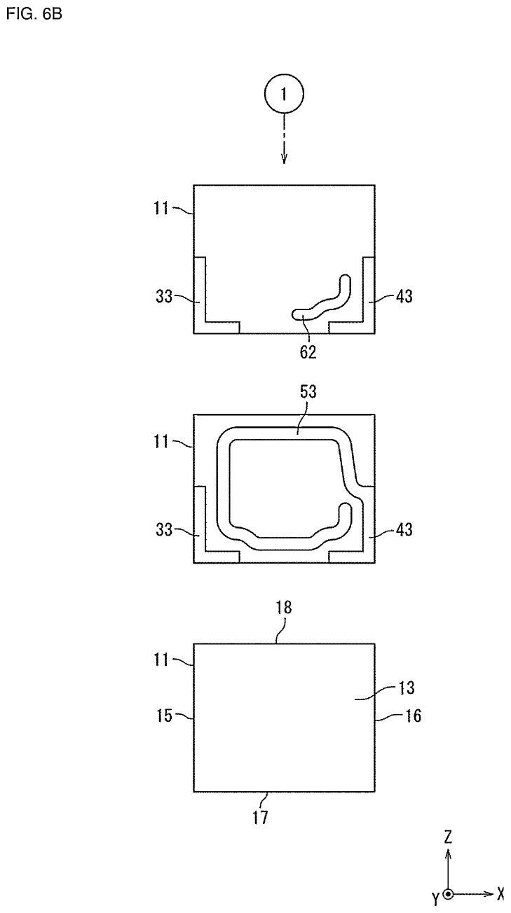

FIG. 5 is a transparent front view of an inductor component according to a second embodiment when viewed from the side of a first side surface of the inductor component. FIGS. 6A and 6B are exploded plan views of the inductor component. The second embodiment differs from the first embodiment in the shape of the coil. This different configuration is described below. Other configurations in the second embodiment are the same as those in the first embodiment, and are denoted by the same reference signs as in the first embodiment and the descriptions thereof are omitted.

As shown in FIGS. 5 and 6A and 6B, in an inductor component 1A of the second embodiment, the shape of a winding portion 20a of a coil 20A is a polygonal annulus, when viewed from the axial AX direction. In other words, the shape of the inner peripheral surface of the coil 20A is polygonal when viewed from the axial AX direction. In this embodiment, the polygon is substantially a square.

The coil 20A is formed along the outer surface of the element body 10, the first outer electrode 30 and the second outer electrode 40, when viewed from the axial AX direction. In other words, the coil 20A includes a portion parallel to the top surface 18, a portion parallel to the first end surface 15, a portion parallel to the bottom surface 17, a portion parallel to the second end surface 16, a portion parallel to the first outer electrode 30, and a portion parallel to the second outer electrode 40.

The coil 20A has first to third coil wiring layers 51 to 53 stacked along the axis AX, and first and second via wiring layers 61 and 62 each positioned between the coil wiring layers adjacent to each other in the axial AX direction and connecting the coil wiring layers adjacent to each other in the axial AX direction. The coil wiring layers adjacent to each other in the stacking direction are electrically connected in series via the via wiring layer. Thus, the plurality of coil wiring layers 51 to 53 constitute a spiral while being electrically connected in series with each other.

The number of turns of each of the coil wiring layers 51 to 53 is less than one turn, but may be one or more turns. Each of the coil wiring layers 51 to 53 consists of straight portions and curved portions, when viewed from the axial AX direction. The curved portion is formed by a plurality of consecutive circular arcs.

The length of each of the via wiring layers 61 and 62 in the extension direction is shorter than the length of each of the coil wiring layers 51 to 53 in the extension direction. Each of the via wiring layers 61 and 62 consists of a curved portion, when viewed from the axial AX direction. The curved portion is formed by a plurality of consecutive circular arcs.

Similarly to the coil 20 of the first embodiment described above, the first inner diameter dimension D1 is larger than the inner diameter dimension of the second inner diameter dimension D2, and the ratio of the absolute value of the difference between the first inner diameter dimension D1 and the second inner diameter dimension D2 to the second inner diameter dimension D2 (the ratio of the difference in inner diameter dimension) is 0.1% or more and 11% or less (i.e., from 0.1% to 11%). The ratio of the difference in inner diameter dimension is preferably 1% or more and 8% or less (i.e., from 1% to 8%), and more preferably 4% or more and 5% or less (i.e., from 4% to 5%). The difference between the first inner diameter dimension D1 and the second inner diameter dimension D2 is 0.15 μm or more and 1.5 μm or less (i.e., from 0.15 μm to 1.5 μm).

As in the element body 10 of the first embodiment described above, the length dimension L of the element body 10 is larger than the height dimension T of the element body 10, when viewed from the axial AX direction. Preferably, the length dimension L of the element body 10 is 0.20 mm or more and 0.30 mm or less (i.e., from 0.20 mm to 0.30 mm). The height dimension T of the element body 10 is 0.15 mm or more and 0.25 mm or less (i.e., from 0.15 mm to 0.25 mm). More preferably, the length dimension L of the element body 10 is 0.25 mm and the height dimension T of the element body 10 is 0.20 mm.

With the above configuration, since the ratio of the difference in inner diameter dimension is 0.1% or more, the area of the inner side of the coil 20A can be increased compared to the case where the shape of the inner peripheral surface of the coil is a perfect circle, thereby significantly improving the L value. Further, since the ratio of the difference in inner diameter dimension is 11% or less, the line length of the coil 20A can be shortened to reduce the resistance compared to the case where the shape of the inner peripheral surface of the coil is a horizontally long ellipse or rectangle, and the value of Q value/L value can be kept at 2.5 or higher. Therefore, by keeping the shape of the inner peripheral surface of the coil 20A close to a square, the value of Q value/L value can be kept at 2.5 or higher while securing the L value. By keeping the value of Q value/L value at 2.5 or higher, the Q value acquisition efficiency can be improved.

Further, since the first inner diameter dimension D1 is larger than the second inner diameter dimension D2, when the length dimension L of the element body 10 is larger than the height dimension T of the element body 10, the shape of the inner peripheral surface of the coil 20A can be caused to correspond to the shape of the outer surface of the element body 10 when viewed from the axial AX direction. Thus, it is possible to effectively use the space inside the element body 10 with respect to the coil 20A, increase the area of the inner side of the coil 20A, and improve the L value acquisition efficiency.

Further, since the first inner diameter dimension D1 is larger than the second inner diameter dimension D2, when the inductor component 1A is mounted on a mounting substrate so that the bottom surface 17 of the element body 10 faces the mounting substrate side, the coil 20A can be separated from the mounting substrate, thus reducing stray capacitance with the mounting substrate.

Further, since the length dimension L of the element body 10 is 0.20 mm or more and 0.30 mm or less (i.e., from 0.20 mm to 0.30 mm) and the height dimension T of the element body 10 is 0.15 mm or more and 0.25 mm or less (i.e., from 0.15 mm to 0.25 mm), the shape of the outer surface of the element body 10, when viewed from the axial AX direction, is suitable for the shape of the inner peripheral surface of the coil 20A in which the ratio of the difference in inner diameter dimension is 0.1% or more and 11% or less (i.e., from 0.1% to 11%), so that the space inside the element body 10 can be used effectively with respect to the coil 20A.

### Third Embodiment

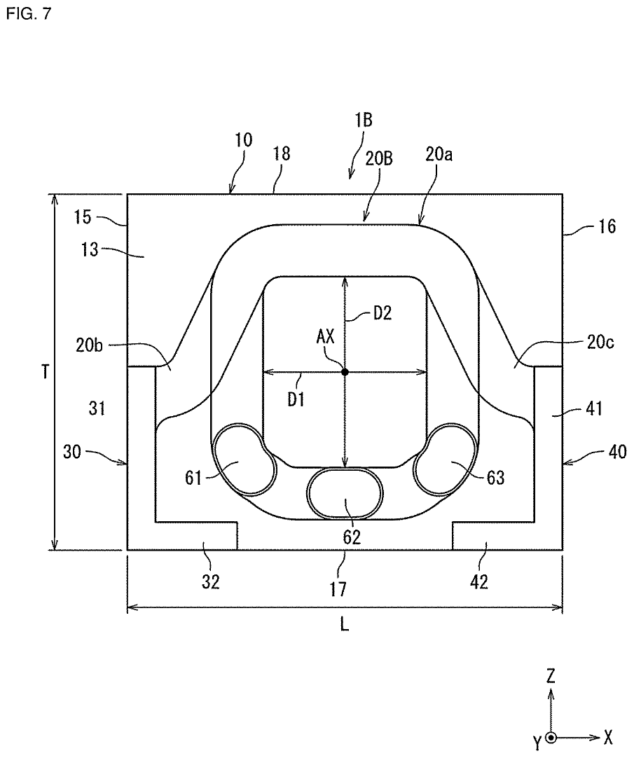

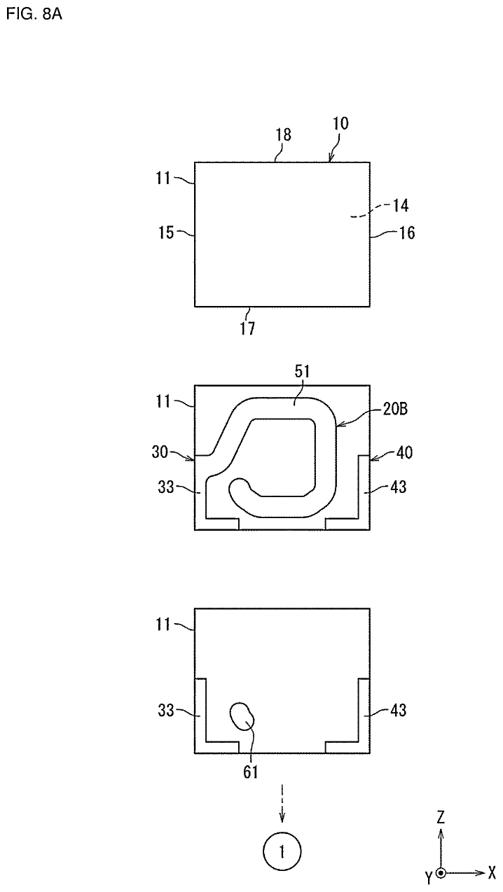

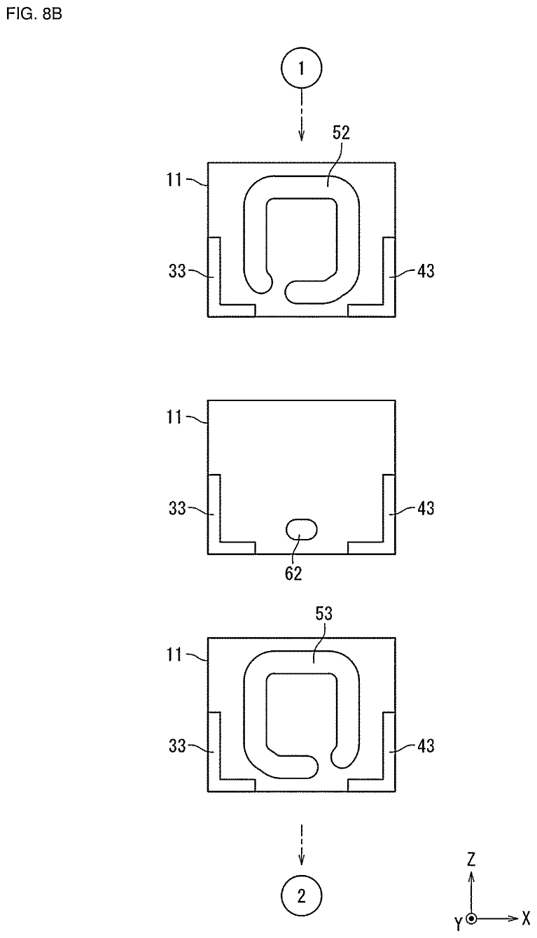

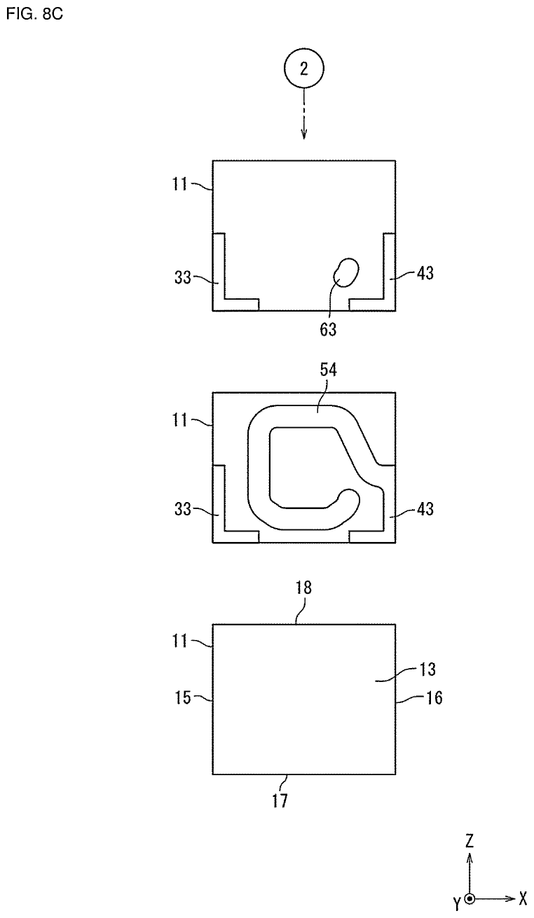

FIG. 7 is a transparent front view of an inductor component according to a third embodiment when viewed from the side of a first side surface of the inductor component. FIGS. 8A, 8B and 8C are exploded plan views of the inductor component. The third embodiment differs from the first embodiment in the shape of the coil. This different configuration is described below. Other configurations in the third embodiment are the same as those in the first embodiment, and are denoted by the same reference signs as in the first embodiment and the descriptions thereof are omitted.

As shown in FIGS. 7 and 8A, 8B, and 8C, in an inductor component 1B of the third embodiment, the shape of a winding portion 20a of a coil 20B is a polygonal annulus, when viewed from the axial AX direction. In other words, the shape of the inner peripheral surface of the coil 20B is polygonal when viewed from the axial AX direction. In this embodiment, the polygon is substantially a square.

The coil 20B is formed along the outer surface of the element body 10, the first outer electrode 30 and the second outer electrode 40, when viewed from the axial AX direction. In other words, the coil 20B includes a portion parallel to the top surface 18, a portion parallel to the first end surface 15, a portion parallel to the bottom surface 17, a portion parallel to the second end surface 16, a portion parallel to the first outer electrode 30, and a portion parallel to the second outer electrode 40.

The coil 20B has first to fourth coil wiring layers 51 to 54 stacked along the axis AX, and first to third via wiring layers 61 to 63 each positioned between coil wiring layers adjacent to each other in the axial AX direction and connecting the coil wiring layers adjacent to each other in the axial AX direction. The coil wiring layers adjacent to each other in the stacking direction are electrically connected in series via the via wiring layer. Thus, the plurality of coil wiring layers 51 to 54 constitute a spiral while being electrically connected in series with each other.

The number of turns of each of the coil wiring layers 51 to 54 is less than one turn, but may be one or more turns. Each of the coil wiring layers 51 to 54 consists of straight portions and curved portions, when viewed from the axial AX direction. The curved portion is formed by a plurality of consecutive circular arcs.

The length of each of the via wiring layers 61 to 63 in the extension direction is shorter than the length of each of the coil wiring layers 51 to 54 in the extension direction. Each of the via wiring layers 61 to 63 consists of a curved portion, when viewed from the axial AX direction. The curved portion is formed by a circular arc.

The second inner diameter dimension D2 is larger than the inner diameter dimension of the first inner diameter dimension D1, and the ratio of the absolute value of the difference between the first inner diameter dimension D1 and the second inner diameter dimension D2 to the first inner diameter dimension D1 (the ratio of the difference in inner diameter dimension) is 0.1% or more and 11% or less (i.e., from 0.1% to 11%). The ratio of the difference in inner diameter dimension is preferably 1% or more and 8% or less (i.e., from 1% to 8%), and more preferably 4% or more and 5% or less (i.e., from 4% to 5%). The difference between the first inner diameter dimension D1 and the second inner diameter dimension D2 is 0.15 μm or more and 1.5 μm or less (i.e., from 0.15 μm to 1.5 μm).

As in the element body 10 of the first embodiment described above, the length dimension L of the element body 10 is larger than the height dimension T of the element body 10, when viewed from the axial AX direction. Preferably, the length dimension L of the element body 10 is 0.20 mm or more and 0.30 mm or less (i.e., from 0.20 mm to 0.30 mm). The height dimension T of the element body 10 is 0.15 mm or more and 0.25 mm or less (i.e., from 0.15 mm to 0.25 mm). More preferably, the length dimension L of the element body 10 is 0.25 mm and the height dimension T of the element body 10 is 0.20 mm.

With the above configuration, since the ratio of the difference in inner diameter dimension is 0.1% or more, the area of the inner side of the coil 20B can be increased compared to the case where the shape of the inner peripheral surface of the coil is a perfect circle, thereby significantly improving the L value. Further, since the ratio of the difference in inner diameter dimension is 11% or less, the line length of the coil 20B can be shortened to reduce the resistance compared to the case where the shape of the inner peripheral surface of the coil is a vertically long ellipse or rectangle, and the value of Q value/L value can be kept at 2.5 or higher. Therefore, by keeping the shape of the inner peripheral surface of the coil 20B close to a square, the value of Q value/L value can be kept at 2.5 or higher while securing the L value. By keeping the value of Q value/L value at 2.5 or higher, the Q value acquisition efficiency can be improved.

Further, since the second inner diameter dimension D2 is larger than the first inner diameter dimension D1, when the first outer electrode 30 is L-shaped and provided at the bottom surface 17 and the first end surface 15 and the second outer electrode 40 is L-shaped and provided at the bottom surface 17 and the second end surface 16, the coil 20B can be separated from the first outer electrode 30 and the second outer electrode 40, thus reducing stray capacitance with the first outer electrode 30 and the second outer electrode 40.

Further, since the length dimension L of the element body 10 is 0.20 mm or more and 0.30 mm or less (i.e., from 0.20 mm to 0.30 mm), and the height dimension T of the element body 10 is 0.15 mm or more and 0.25 mm or less (i.e., from 0.15 mm to 0.25 mm), the shape of the outer surface of the element body 10, when viewed from the axial AX direction, is suitable for the shape of the inner peripheral surface of the coil 20B in which the ratio of the difference in inner diameter dimension is 0.1% or more and 11% or less (i.e., from 0.1% to 11%), so that the space inside the element body 10 can be used effectively with respect to the coil 20B.

### Other Embodiments

The present disclosure is not limited to the embodiments described above, and can be changed in design without departing from the scope of the present disclosure. For example, the features of each of the first to three embodiments may be combined in various ways. For example, the number of layers of the coil wiring layer may be increased or decreased, and the number of layers of the via wiring layer may be increased or decreased.

The dimension of the element body in the length direction may be smaller than the dimension of the element body in the height direction. The winding portion of the coil may be formed in a spiral shape when viewed from the axial direction. The first outer electrode and the second outer electrode may be provided only on the bottom surface of the element body.

The end portion of the coil wiring layer may have a pad portion, and adjacent coil wiring layers may be connected by a columnar via layer. The diameter of the pad portion is larger than the line width of the middle portion of the coil wiring layer.

### EXAMPLES

An example of the inductor component 1 described in the first embodiment will be described below.

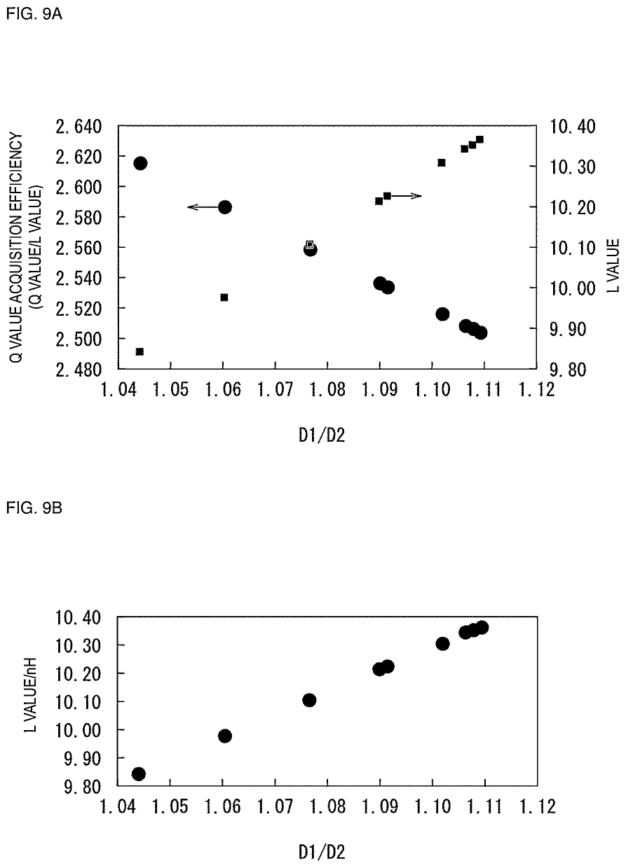

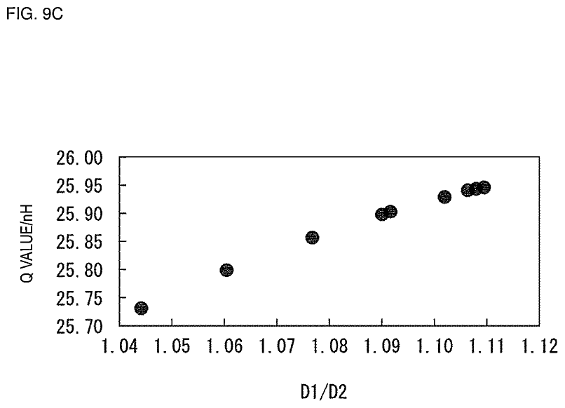

FIG. 9A is a graph showing the relationship between the ratio between the inner diameter dimensions and the Q value acquisition efficiency. In FIG. 9A, the horizontal axis represents “first inner diameter dimension D1/second inner diameter dimension D2”, which is the ratio between the inner diameter dimensions, and the vertical axis represents “Q value/L value”, which is the Q value acquisition efficiency. FIG. 9B is a graph showing the relationship between the ratio between the inner diameter dimensions and the L value. In FIG. 9B, the horizontal axis represents “first inner diameter dimension D1/second inner diameter dimension D2”, and the vertical axis represents the L value [nH]. FIG. 9C is a graph showing the relationship between the ratio between the inner diameter dimensions and the Q value. In FIG. 9C, the horizontal axis represents “first inner diameter dimension D1/second inner diameter dimension D2”, and the vertical axis represents the Q value [nH]. FIGS. 9A, 9B and 9C show the values when the second inner diameter dimension D2 is kept constant and the first inner diameter dimension D1 is changed. The second inner diameter dimension D2 is, for example, 159 μm.

As shown in FIG. 9A, the larger the ratio of the difference in inner diameter dimension (i.e., the larger the first inner diameter dimension D1), the larger the ratio of the Q value to the L value. As shown in FIG. 9B, the larger the ratio of the difference in inner diameter dimension (i.e., the larger the first inner diameter dimension D1), the larger the L value. As shown in FIG. 9C, the larger the ratio of the difference in inner diameter dimension (i.e., the larger the first inner diameter dimension D1), the larger the Q value. Therefore, when the ratio of the difference in inner diameter dimension is 0.1% or more and 11% or less (i.e., from 0.1% to 11%), the ratio of Q value/L value can be kept at 2.5 or higher while securing the L value. By keeping the value of Q value/L value at 2.5 or higher, the Q value acquisition efficiency can be improved.

In the above example, the ratio of first inner diameter dimension D1/second inner diameter dimension D2 is used for the horizontal axis, but the same results can be obtained when second inner diameter dimension D2/first inner diameter dimension D1 is 1.01 or higher, i.e., when the second inner diameter dimension D2 is larger than the first inner diameter dimension D1.

The present disclosure includes the following aspects:
<1> An inductor component comprising an element body, a coil provided in the element body and spirally wound along an axis, and a first outer electrode and a second outer electrode provided in the element body and electrically connected to the coil. The element body includes a first end surface and a second end surface facing each other, a first side surface and a second side surface facing each other, a bottom surface connected between the first end surface and the second end surface and between the first side surface and the second side surface, and a top surface facing the bottom surface. The first outer electrode and the second outer electrode are provided at least on the bottom surface, and the axis is parallel to the bottom surface and intersects the first side surface and the second side surface. Also, when viewed from an axial direction, the inner diameter of the coil includes a first inner diameter dimension in a length direction in which the first end surface and the second end surface face each other and a second inner diameter dimension in a height direction in which the top surface and the bottom surface face each other, and the inner diameter dimension of one of the first inner diameter dimension and the second inner diameter dimension is larger than the inner diameter dimension of the other. In addition, the ratio of the absolute value of the difference between the inner diameter dimension of the aforesaid one and the inner diameter dimension of the aforesaid other to the inner diameter dimension of the aforesaid other is 0.1% or more and 11% or less (i.e., from 0.1% to 11%).
<2> The inductor component according to <1>, wherein the inner diameter dimension of the aforesaid one is the first inner diameter dimension and the inner diameter dimension of the aforesaid other is the second inner diameter dimension.
<3> The inductor component according to <2>, wherein the dimension of the element body in the length direction is greater than the dimension of the element body in the height direction, when viewed from the axial direction.
<4> The inductor component according to <1>, wherein the inner diameter dimension of the aforesaid one is the second inner diameter dimension and the inner diameter dimension of the aforesaid other is the first inner diameter dimension.
<5> The inductor component according to <4>, wherein the first outer electrode is provided on the bottom surface and the first end surface, and the second outer electrode is provided on the bottom surface and the second end surface.
<6> The inductor component according to any one of <1> to <5>, wherein the dimension of the element body in the length direction is larger than the dimension of the element body in the height direction when viewed from the axial direction, the dimension of the element body in the length direction being 0.20 mm or more and 0.30 mm or less (i.e., from 0.20 mm to 0.30 mm), the dimension of the element body in the height direction being between 0.15 mm and 0.25 mm.

What is claimed is:

1. An inductor component comprising:
an element body including a first end surface and a second end surface facing each other, a first side surface and a second side surface facing each other, a bottom surface connected between the first end surface and the second end surface and between the first side surface and the second side surface, and a top surface facing the bottom surface,
a coil in the element body and spirally wound along an axis, and
a first outer electrode and a second outer electrode in the element body and electrically connected to the coil,
wherein
the first outer electrode and the second outer electrode are at least on the bottom surface,
the axis is parallel to the bottom surface and intersects the first side surface and the second side surface,
when viewed from an axial direction,
an inner diameter of the coil includes a first inner diameter dimension in a length direction in which the first end surface and the second end surface face each other and a second inner diameter dimension in a height direction in which the top surface and the bottom surface face each other, and
a dimension of one of the first inner diameter dimension and the second inner diameter dimension is larger than an other dimension of the other of the first inner diameter dimension and the second inner diameter dimension, and
a ratio of an absolute value of a difference between the dimension and the other dimension to the other dimension is from 0.1% to 11%.

2. The inductor component according to claim 1, wherein
the dimension is the first inner diameter dimension, and
the other dimension is the second inner diameter dimension.

3. The inductor component according to claim 2, wherein
a dimension of the element body in the length direction is greater than a dimension of the element body in the height direction, when viewed from the axial direction.

4. The inductor component according to claim 1, wherein
the dimension is the second inner diameter dimension, and
the other dimension is the first inner diameter dimension.

5. The inductor component according to claim 4, wherein
the first outer electrode is on the bottom surface and the first end surface, and
the second outer electrode is on the bottom surface and the second end surface.

6. The inductor component according to claim 1, wherein
a dimension of the element body in the length direction is larger than a dimension of the element body in the height direction when viewed from the axial direction,
the dimension of the element body in the length direction being from 0.20 mm to 0.30 mm,
the dimension of the element body in the height direction being from 0.15 mm to 0.25 mm.

7. The inductor component according to claim 2, wherein
a dimension of the element body in the length direction is larger than a dimension of the element body in the height direction when viewed from the axial direction,
the dimension of the element body in the length direction being from 0.20 mm to 0.30 mm,
the dimension of the element body in the height direction being from 0.15 mm to 0.25 mm.

8. The inductor component according to claim 3, wherein
a dimension of the element body in the length direction is larger than a dimension of the element body in the height direction when viewed from the axial direction,
the dimension of the element body in the length direction being from 0.20 mm to 0.30 mm,
the dimension of the element body in the height direction being from 0.15 mm to 0.25 mm.

9. The inductor component according to claim 4, wherein
a dimension of the element body in the length direction is larger than a dimension of the element body in the height direction when viewed from the axial direction,
the dimension of the element body in the length direction being from 0.20 mm to 0.30 mm,
the dimension of the element body in the height direction being from 0.15 mm to 0.25 mm.

10. The inductor component according to claim 5, wherein
a dimension of the element body in the length direction is larger than a dimension of the element body in the height direction when viewed from the axial direction,
the dimension of the element body in the length direction being from 0.20 mm to 0.30 mm,
the dimension of the element body in the height direction being from 0.15 mm to 0.25 mm.
